(19) United States
(12) Patent Application Publication
(10) Pub. No.: US 2022/0154668 A1
(43) Pub. Date: May 19, 2022

(54) UNIVERSAL VALVE COVER

(71) Applicants: Wayne Douglas Nixon, Arendal (NO); William John Schaffhouser, New Tripoli, PA (US)

(72) Inventors: Wayne Douglas Nixon, Arendal (NO); William John Schaffhouser, New Tripoli, PA (US)

(21) Appl. No.: 17/528,909

(22) Filed: Nov. 17, 2021

Related U.S. Application Data
(60) Provisional application No. 63/115,342, filed on Nov. 18, 2020.

(51) Int. Cl. F02F 7/00

(52) U.S. Cl. CPC F02F 7/006

(57) ABSTRACT

The present invention provides an improved two-piece valve cover comprising an elliptical walled support with a sloped cover configured for connection to said elliptical walled support and having an upper surface and a lower surface, sloped cover presenting at least a partially sloped surface wherein the upper surface is at least partially angled towards the lower surface and a central plenum extending at least partially through said elliptical walled support and at least a portion through said sloped cover.

### FIELD OF THE INVENTION

The current invention relates in general to an improved valve cover for use on an engine, and more specifically to an improved two-piece valve cover with a circumscribing well extending along the improved valve cover.

### BACKGROUND OF THE INVENTION

Multi-cycle stroke combustion engines utilize engine oil for lubrication of during the reciprocal movement of the valves. Covers are typically placed over the valves to seal them from the surrounding environment, prevent contamination of the engine and the loss of engine oil. Many of these valve covers utilize a unitary piece of metal or plastic which must be removed to gain access to the valves and for inspection or repair. It would be beneficial to have a valve cover which allowed for access without removal of the entire unitary cover assembly.

In use, conventional valve covers are unitary and have a downwardly depending lip which receives a cork or rubber gasket which is then used to help securely attach the unitary valve cover to the underlying engine block and to seal the valves. Over time these gaskets breakdown, crack and fail allowing the lubricating oil to leak out from the around the valve cover and onto the engine block. To fix or repair the gasket, the entire valve cover has to be removed, the gasket has to be scraped and a new gasket has to be substituted. It would be beneficial to provide a structure for capturing oil which leaks from around the valve cover in the event of a gasket failure and to place a gasket a distance from the engine block to help reduce the high temperatures.

Conventional valve assemblies often utilize rockers and pushrods for movement of the valves. These rockers and pushrods can become damaged during use. In addition, depending on the desired engine characteristics, the rockers and pushrods may need to be adjusted, altered or changed to allow for the desired modification of the engine operating parameters. Access to these rockers and pushrods through a conventional valve cover requires that the entire valve cover be removed, the gasket removed and scraped from the engine block in order to access the desired valve components. This can take significant time and energy. It would thus be beneficial to provide a valve cover which provided quick access to the rockers and pushrods for adjustment or removal.

In some cases, the valve train needs to be inspected or adjusted. In order to gain sufficient access various parts and wires need to be moved in order to get to open the valve cover. In addition, opening or removing the valve cover on a one-piece valve cover can damage the valve cover gasket. It would therefore be of further benefit to provide a valve cover which provides access to the valve train for inspection and adjustment without the need to remove various wires and parts and which does not damage the valve cover gasket.

Therefore, there is a need for a two-piece valve cover which addresses some of the aforementioned shortcomings such as being customizable, providing quick and ready access to the valve components and/or provides an improved oil recycling structure for recycling engine oil.

### SUMMARY OF THE INVENTION

In an embodiment of the present invention, the foregoing is addressed by providing an improved two-piece valve cover comprising an elliptical walled support, a sloped cover configured for connection to said elliptical walled support and having an upper surface and a lower surface, said sloped cover presenting at least a partially sloped surface wherein said upper surface is at least partially angled towards said lower surface, said sloped cover removably secured to said elliptical walled support and a central plenum extending through said elliptical walled support and at least a portion through said sloped cover.

### BRIEF DESCRIPTION OF THE DRAWINGS

FIG. 1 is a right-side perspective view of an embodiment of the improved universal valve cover in accordance with one embodiment of the present invention in a closed position.

FIG. 2 is a front perspective view of an embodiment of the improved universal valve cover in an open position in accordance with the embodiment depicted in FIG. 1.

FIG. 3 is a left-side perspective view of an embodiment of an embodiment of the elliptical walled support in accordance with the embodiment depicted in FIG. 1.

FIG. 4 is a magnified fragmentary left-side perspective of an embodiment of the elliptical walled support as shown in FIG. 3.

FIG. 5 is a bottom perspective view of an embodiment of a sloped cover in accordance with the embodiment depicted in FIG. 2.

FIG. 6 is a cross section of an embodiment of the improved universal valve cover in accordance with the embodiment depicted in FIG. 1.

### DETAILED DESCRIPTION

Certain terminology will be used in the following description for convenience in reference only and will not be limiting. For example, top, bottom, front, back, right and left refer to the illustrated embodiment as oriented in the view being referred to. The words “upwardly” and “downwardly” refer to directions up or down and away from, respectively, the geometric center of the embodiment being described and designated parts thereof. Such terminology will include the words specifically mentioned, derivatives thereof and words of similar meaning.

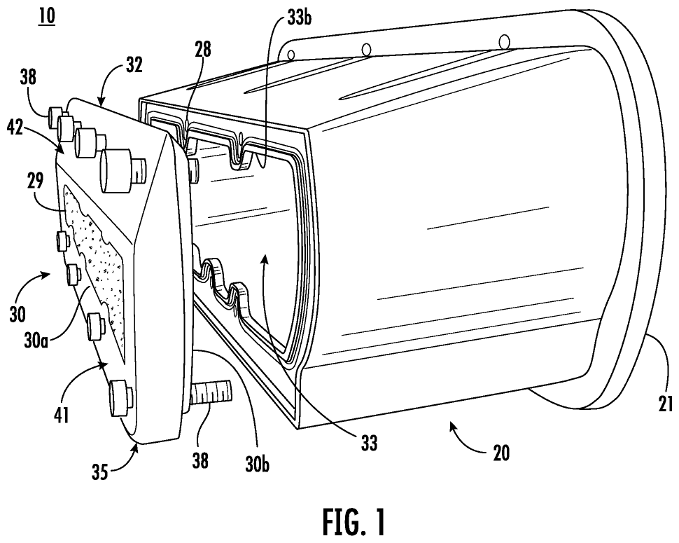

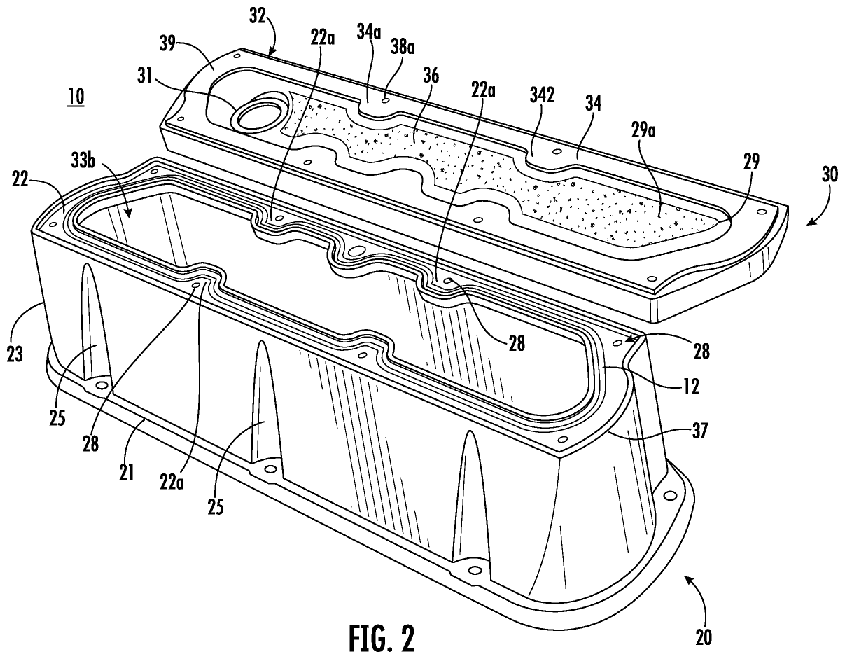

Referring to FIG. 1, an embodiment of the improved two-piece valve cover generally referred to with reference numeral 10 has an elliptical walled support 20 configured for removably receiving a sloped cover 30. The elliptical walled support 20 further includes an upper mounting surface 22 and a lower well 24. In the embodiment depicted in FIGS. 1-2, a circumferential channel 40 extends along the upper mounting surface 22 between the upper mounting surface 22 and the lower well 24 and is configured for receiving a gasket 12. Further, the embodiment of FIGS. 1-2 presents the lower well 24 with a bias 26, also referred to herein as a second mounting surface, extending from the lower well 24 into a central plenum 33.

The gasket 12 has a substantially planar surface with a nominal thickness and is generally configured for providing a fluid resistant seal between the sloped cover 30 and the elliptical walled support 20. In addition, the gasket 12 is configured with material which provides for limited expansion during high temperature operations. By way of example, the gasket 12 may be fabricated from heat resistant cork, plastic, metal, paper, felt, neoprene, nitrile rubber, fiberglass, or silicone material.

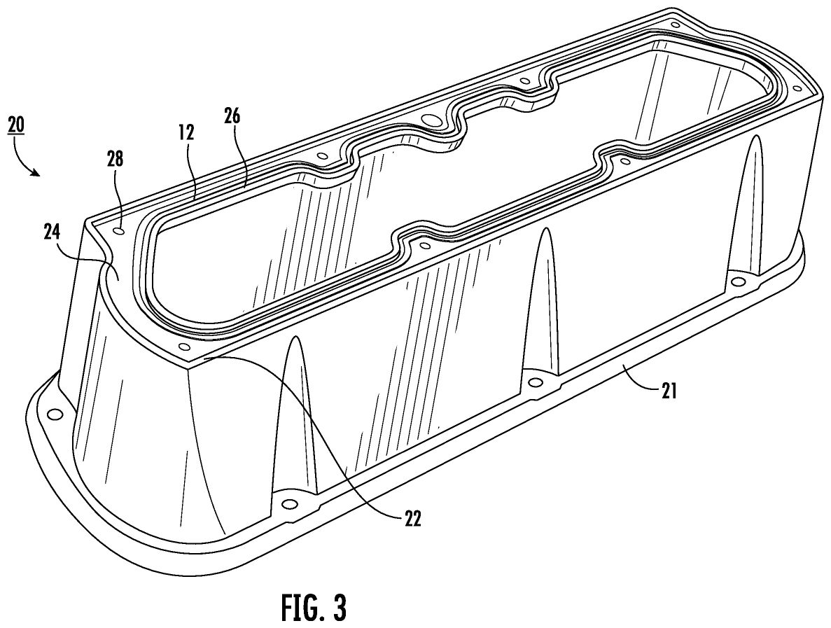

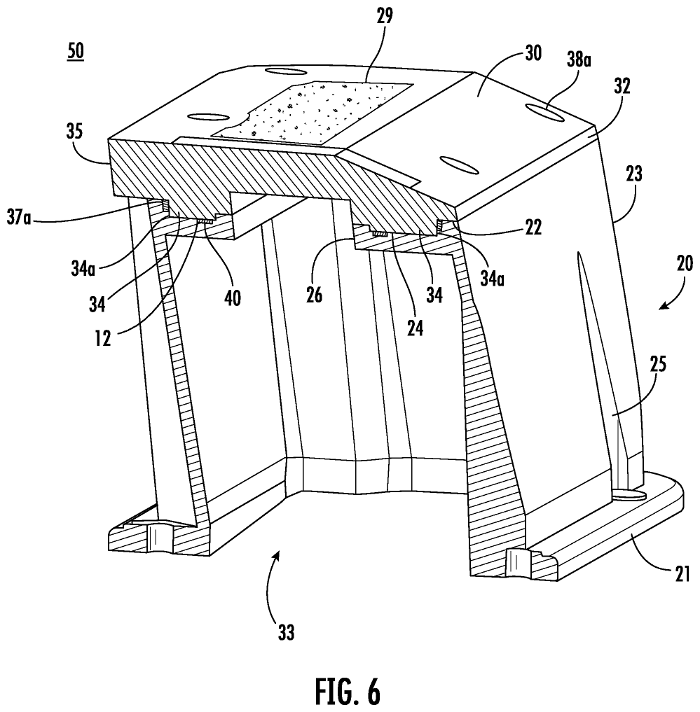

Generally, the elliptical walled support 20 is a rounded linear structure which extends from an engine block (not shown) and includes a lower mounting flange 21. The elliptical walled support 20 is secured to the engine block with mechanical fasteners. As depicted in FIG. 3, the elliptical walled support 20 extends upwardly from the lower mounting flange 21 and as depicted in FIG. 6 has a generally fustro-pyramidal configuration with the lower mounting flange 21 encircling the elliptical walled support 20. The elliptical walled support 20 has a number of channels extending upward from the lower mounting flange 21 which are configured for receiving a plurality of spaced fasteners thereabout for securing the elliptical walled support 20 to the underlying combustion engine.

A central plenum 33 extends through the elliptical walled support 20 and is presented at a generally elliptical opening or window 33b. The elliptical window 33b extends inwardly from the bias 26. Fascia 29 has a generally appealing visual appearance and may be customized as desired to include various symbols, letters or patterns. In general, the fascia 29 is extended along an outer surface 30a associated with the sloped cover 30. In one embodiment, the outer surface 30a is removable. Removal of the outer surface 30a from the sloped cover 30 presents a complementary window 29a which provides access to the central plenum 33. In general, the complementary window 29a corresponds to the elliptical window 36 in the elliptical walled support 20 for communication therethrough. In combination, the complementary window 29a and elliptical opening 33b allow for communication through the central plenum 33 to any underlying drive train components (not shown) and any fluid reservoir (not shown).

The elliptical window 36 and corresponding complementary window 29a are depicted in FIG. 2. As depicted, the elliptical window 33b and the complementary window 29a are both generally elliptical with various curved regions 22a, 34a extending inwardly. The elliptical window 33b includes a number of variously curved segments which are associated with the curved bodies 22a extending inwardly towards the central plenum 33 from the upper mounting surface 22. Each curved body 22a is generally associated with a fastener receiver 28 and provides additional sidewall support. The complementary window 29a also includes various curved regions 34a associated with the depending mounting surface 34

The elliptical walled support 20 generally includes a peripheral sidewall 23 which extends circumferentially along a generally elliptical path from the mounting flange 21 to the upper mounting surface 22. In one embodiment, the elliptical walled support 20 will be a cast metal base which is adapted for handling the heat associated with the underlying engine. The mounting flange 21 provides an additional capturing structure for retention of oil which may leaking from the junction of the elliptical walled support 20 on the underlying motor surface (not shown).

As illustrated in the alternative embodiment of the improved two-piece valve cover 50 of FIG. 6, the elliptical walled support 60 presents a circumferential channel 40 within the upper mounting surface 22. The circumferential channel 40 is spaced from the engine block (not shown) for receipt of the gasket 12. By spacing the position of the gasket 12 a sufficient distance from the engine block, reducing the operational temperatures experienced by the gasket 12 and increasing the longevity of the resilience and lifespan of the gasket 12. The elliptical walled support 20 provides sufficient spacing for containing splashing oil during operation of the underlying combustion engine.

The peripheral sidewall 23 encircles a central plenum 33 which extends between the elliptical walled support 20 and the sloped cover 30 and provides communication through the two-piece valve cover 10 to the underlying engine (not shown). The central plenum 33 is generally designed to provide sufficient support for inspection or adjustment of the underlying drive train components or valves. In this way, the removal of the sloped cover 30 allows for easy inspection, easy adjustment without the need to remove the elliptical walled support 20.

The upper mounting surface 22 associated with the elliptical walled surface 20 depicted is separated from the lower well 24 by the circumferential channel 40. The embodiment of the upper mounting surface 22 depicted in FIGS. 1-2 is illustrated as being substantially coplanar with the lower well 24. The upper mounting surface 22 extends radially from the lower well 24 towards a recycler 37 which is also referred to as a circumscribing sidewall 37.

The recycler 37 depicted in FIGS. 1-2 extends upwardly from the upper mounting surface 22 along the peripheral sidewall 23. The recycler 37 allows for the retention of any escaping liquids which pass through the gasket 12, for example, in the event of a malfunction, breakdown or disintegration of the gasket 12. Generally, the recycler 37 is complementary configured for receipt of the depending mounting surface 34 which extends from the sloped cover 30. As depicted in FIG. 6, the recycler 37a includes an upwardly extending vertical sidewall configured for complementary engagement with the outer wall of a downwardly depending vertical surface 34a extending from the depending mounting surface 34.

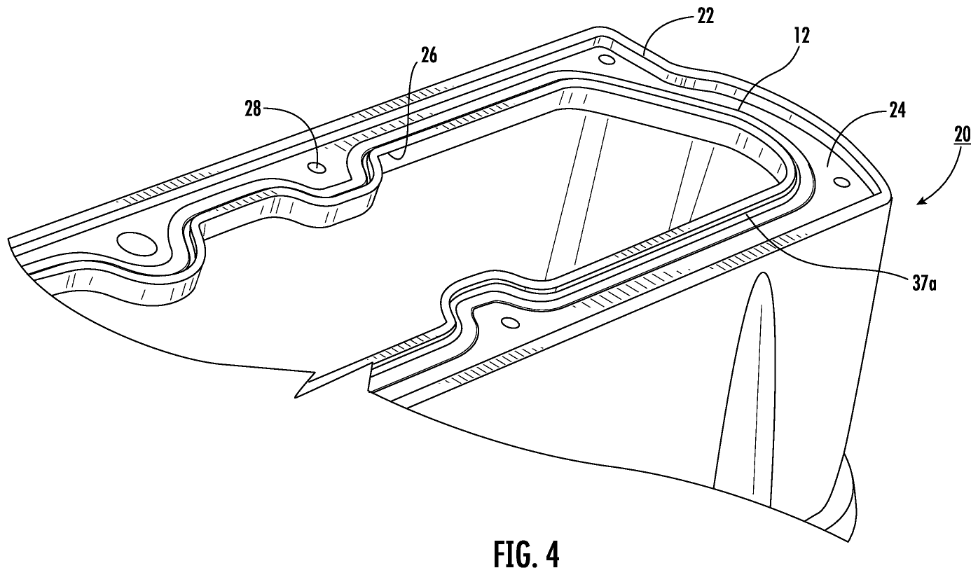

An alternative recycler 37a is depicted in FIG. 3 extending between the lower well 24 and the upper mounting surface 22. The upper mounting surface 22 depicted in the embodiment depicted in FIGS. 3-4 is substantially planar with the lower well 24 and circumferential channel 40 being vertically offset from the upper mounting surface 22. The alternative recycler 37a provides a generally elliptical groove for receiving and retaining any escaping oil (not shown). Optionally, the alternative recycler 37a may include a bias 26 towards the central plenum. The bias 26 having a slight angular inclination or radiused edge may be sufficient to help return any contained fluids back to the plenum 33 where an oil reserve may be located and were the drive train components are located.

The lower well 24 is illustrated in the depicted embodiment as being recessed within the upper mounting surface 22. The lower well 24 is complementary configured for engagement with the sloped surface 30. Generally, the lower well 24 depicted in FIG. 3-4, 6 is recessed from the upper mounting surface 22 and includes the circumferential channel 40, for receiving the gasket 12, and the bias 26. Generally, the lower well 24 extends radially inwardly from the upper mounting surface 22 to the bias 26.

The bias 26 has a generally smooth surface and presents a sealing member which acts as a barrier for any retained oil. The bias 26 allows reintroduction of the retained oil (not shown) into the central plenum 33. In one embodiment, the bias 26 has a slight slope towards the central plenum 33. Alternatively, the bias 26 may be planar. The embodiment of the bias 26 depicted in FIGS. 3-4 extends from the edge of the circumferential channel 40 to the central plenum 33.

In the embodiment depicted in FIGS. 3-4, the gasket 12 presents a barrier between the lower well 24 and the bias 26. As further illustrated in the embodiment of FIG. 6, the gasket 12 is configured for sealing engagement with a complementary configured depending mounting surface 34. The gasket 12 has a generally planar upper surface fabricated from a high-temperature resilient material which is generally compatible with use with hydrocarbons.

The sloped cover 30 extends from a generally tapered distal front 32 to a spaced apart proximate rear 35. The sloped cover 30 is generally secured to the lower walled support 20 with a plurality of threaded fasteners 38 which are spaced radially along the junction between the wedge-shaped cover 30 and the elliptical walled support 20. As illustrated in FIG. 1, the elliptical walled support 20 includes a plurality of threaded receivers 28 for receipt of the threaded fasteners 38.

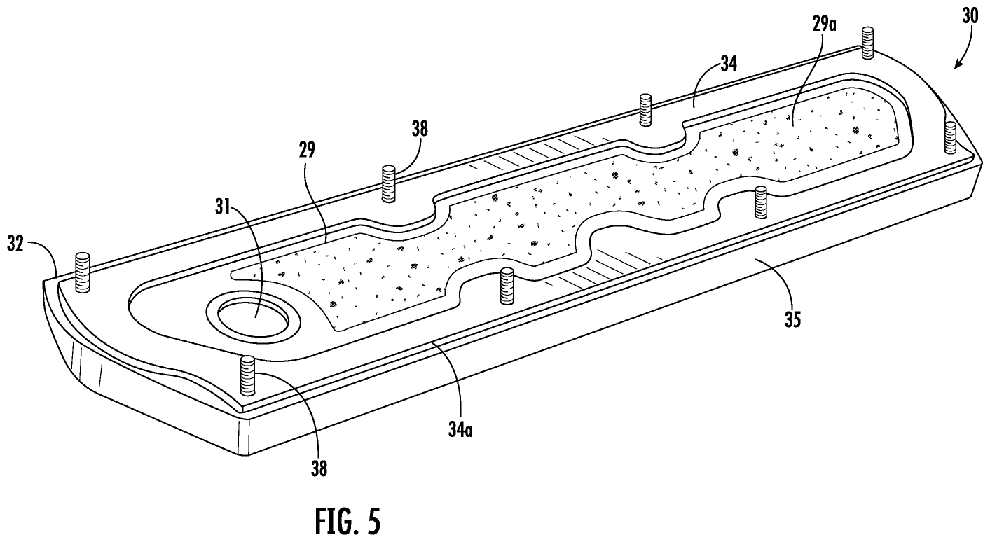

The sloped cover 30 includes a depending mounting surface 34 which has a complementary structure for receipt by the upper mounting surface 22. As depicted in FIG. 2, an optional circumscribing sidewall 37 may extend vertically from the peripheral sidewall 23 for further receiving the depending mounting surface 34. Generally, the depending mounting surface 34 has a complementary surface for sufficient contact with the substantially planar upper mounting surface 22. In the depicted embodiment, the depending mounting surface 34 is generally planar. Alternatively, the depending mounting surface 34 may be angled corresponding to an angled upper mounting surface (not shown) extending from said elliptical walled structure 20. The depending mounting surface 34 also includes a generally rounded rectangular or elliptical window 36 which is generally accessible upon removal of the fascia 29. When the sloped cover 30 is secured to the upper mounting surface 22 and the fascia 29 is removed, the elliptical window 36 allows for access to the drive train through the central plenum 33. In addition, as illustrated in FIG. 5, an optional cylindrical opening 31 extends through the sloped cover 30 providing desired access to the drive train through the central plenum 33, for example, to provide drive train lubricant (not shown).

In general, the sloped cover 30 has an upper surface 30a and a depending mounting surface 34 which extend from a proximate rear 35 to a distal front 32. Near the distal front 32, the upper surface 30a extends angularly towards the depending mounting surface 34. As depicted, in FIG. 1, the upper surface 30a, includes a planar region 41 near the proximate rear 35 and a sloped region 42 near the distal front 32 where the upper surface 30a extends angularly towards the depending mounting surface 34. The depending mounting surface 34 presents a generally planar surface which corresponds to the upper mounting surface 22. Optionally, the depending mounting surface 34 may include some type of engaging member 39 for at least partially sealed engagement with the upper mounting surface 22. The engaging member 39 may be fabricated from a resilient or solid material. The engaging member 39 may be planar, angular or offset for engagement with the elliptical walled support 20.

Generally, the upper surface 30a extends generally coplanar to the depending mounting surface 34 along the planar region 41 and then angles downwardly towards the depending mounting surface 34 along the sloped region 42. As depicted in the embodiment of FIG. 1, near the proximate rear 35 the upper surface 30a is spaced from the depending mounting surface 34. Near the distal front 32, the upper surface 30a is angled towards the depending mounting surface 34. Other configurations for the sloped cover 30 are possible including where the upper surface 30a and depending mounting surface 34 are substantially planar, are coplanar or angularly offset.

The upper surface 30a includes a number of fasteners 38 for secured connection along the planar region 41 of the sloped cover 30. In one embodiment the fascia 29 is inferior to the engaging member 39. In another embodiment, the fascia 29 extends outwardly from the engaging member 39. In general, the fascia 29 corresponds to engaging member 39.

Generally, the sloped cover 30 includes a plurality of fastener receivers configured for receiving a plurality of fasteners for fixation to the elliptical walled support 20. In one embodiment, the fasteners may be screw fasteners. In another embodiment, the fasteners may be mechanical clips or retainers. Separation of the sloped cover 30 can be done quickly and easily to allow for exchanging the sloped cover 30 with a variety of different sloped covers 30 with alternative fascia. In this way, the sloped cover 30 can be readily altered without the need to remove, change or alter the elliptical walled support 20. Removal of the sloped cover 30 presents a complementary window 29a for access to the central plenum 33.

Generally, the fascia 29 can include a customized surface with a visually appealing indicia, surface or texture such as a chromed surface or a variety of customizable designs and logos. By removing the plural fasteners 38, the sloped cover 30 can be separated from the elliptical walled support 20 and replaced with a different surfaced or designed fascia 29 and then replaced and secured to the elliptical walled support 20. In one embodiment, the fasteners 38 releasably secure the sloped cover 30 to the elliptical walled support 20 through fastener receivers 28 located in the upper mounting surface 22. In one embodiment, the sloped cover 30 provides interchangeable visual surfaces which are releasably secured to the elliptical walled support 20.

A cross-section of the sloped cover 30 received by the elliptical walled support 20 is illustrated in FIG. 6. 22 As illustrated an embodiment of the peripheral sidewall 23 extends vertically towards the first mounting surface 22. The first mounting surface 22 is spaced from the second mounting surface 26 by a lower well 34 which includes the circumferential channel 40 which is configured for receipt of the depending mounting surface 34 associated with the sloped cover 30. The depicted embodiment of the circumferential channel 40 is configured for receipt of the gasket 12 which extends upwardly for sealing engagement with the depending mounting surface 34 associated with the sloped cover 30. The central plenum 33 extends downwardly from the depending mounting surface 34 associated with the sloped cover 30 through the elliptical walled support 20 providing access to the lower engine components, like the valves and drive train.

As further illustrated in FIG. 6, the sloped cover 30 extends from the proximate rear 35 to the distal front 32 and is generally secured to the elliptical walled structure 20 with mechanical fasteners. Generally, the lower well 24 receives the depending mounting surface 34 for sealing engagement of the sloped cover 30. As illustrated in FIG. 6, the removable gasket 12 is received within the circumferential channel 40. In the operational cross-sectional illustration of FIG. 6, the depending mounting surface 34 is vertically engaged by the circumscribing sidewall 37a and horizontally engaged by the removable gasket 12.

It should be understood that while certain forms of this invention have been illustrated and described, it is not limited thereto except insofar as such limitations are included in the following claims.

What is claimed and desired to be secured by Letters Patent:

1. An improved two-piece valve cover comprising:
an elliptical walled support;
a sloped cover configured for connection to said elliptical walled support and having an upper surface and a lower surface;
said sloped cover presenting at least a partially sloped surface wherein said upper surface is at least partially angled towards said lower surface, and
a central plenum extending through said elliptical walled support and at least a portion through said sloped cover.

2. The improved two-piece valve cover of claim 1 wherein said elliptical walled support further comprises a first mounting surface separated from a second mounting surface by a circumferential channel configured for receiving a gasket therebetween.

3. The improved two-piece valve cover of claim 2 wherein said circumferential channel and said second mounting surface are offset from said first mounting surface by a circumscribing sidewall.

4. The improved two-piece valve cover of claim 2 further comprising a recycler extending upwardly from a first mounting surface.

5. The improved two-piece valve cover of claim 2 further comprising a recycler extending downwardly from a first mounting surface, wherein said recycler includes a bias extending towards said central plenum.

6. The improved two-piece valve cover of claim 2 wherein said first mounting surface presents a lower well for receipt of a depending mounting surface associated with said sloped cover.

7. The improved two-piece valve cover of claim 2 wherein said circumferential channel is configured for receipt of a depending mounting surface associated with said sloped cover.

8. The improved two-piece valve cover of claim 1 wherein said sloped cover extends between a proximate rear to a distal front.

9. The improved two-piece valve cover of claim 8 wherein said proximate rear is associated with a planar region and said distal front is associated with an angled region.

10. The improved two-piece valve cover of claim 2 wherein said sloped cover further comprises a depending mounting surface which corresponds to said second mounting surface.

11. The improved two-piece valve cover of claim 1 wherein said elliptical walled support has a fustro-pyramidal cross-section.
